(19) United States
(12) Patent Application Publication
(10) Pub. No.: US 2017/0223155 A1
(43) Pub. Date: Aug. 3, 2017

(54) TWO COMPONENTS AND MOBILE TERMINAL PROTECTIVE SHELL

(71) Applicant: KECHANG CHANG, New Taipei City (TW)

(72) Inventor: KECHANG CHANG, New Taipei City (TW)

(21) Appl. No.: 15/367,093

(22) Filed: Dec. 1, 2016

(30) Foreign Application Priority Data
Jan. 28, 2016 (CN) 201620086802.3

(51) Int. Cl. H04M 1/02; H04B 1/3888

(52) U.S. Cl. CPC H04M 1/0202; H04B 1/3888

(57) ABSTRACT

This invention relates generally to two components and mobile terminal protective shell, which belongs to the technical field of mobile terminal accessories. A first component, characterized by comprising a first body, wherein the first body is made of an impact-resistant elastic material and comprises a first part, a second part and a third part that are connected in sequence, the first part is a part of a spherical surface, the second part is a part of a cylindrical surface, the third part is also a part of the spherical surface, and the first part, the second part and the third part are in size correspondence. After application of this mobile terminal protective shell, when the mobile terminal directly slides and falls down to the ground, the protective shell can disperse the force to protect the mobile terminal, so that it becomes more suitable for practical use.

### TECHNICAL FIELD

The invention relates to the technical field of mobile terminal accessories, in particular to two components and a mobile terminal protective shell.

### BACKGROUND ART

A mobile terminal protective shell in the prior art is typically a jacket in a shape basically or fully fitting with a mobile terminal, and has a certain degree of elasticity and a receiving space; during an operation of fitting the mobile terminal into the mobile terminal protective shell, the mobile terminal is received within the receiving space via the elasticity of the mobile terminal protective shell. When the mobile terminal is fully received in the receiving space, the mobile terminal protective shell can basically or fully fit with the mobile terminal by its own elasticity.

Generally, the mobile protective shell is used to prevent the mobile terminal body from being scratched or worn out in a long-term use, which affects the appearance.

The mobile terminal protective shell seldom has other additional features.

### SUMMARY OF THE INVENTION

In view of this, the invention provides two components and a mobile terminal protective shell, where the two components can be assembled together to form the mobile terminal protective shell; after application of this mobile terminal protective shell, when the mobile terminal directly slides and falls down to the ground, the protective shell can disperse the force to protect the mobile terminal, so that it becomes more suitable for practical use.

In order to achieve the first objective, A first component comprises a first body, wherein the first body is made of an impact-resistant elastic material and comprises a first part, a second part and a third part that are connected in sequence, the first part is a part of a spherical surface, the second part is a part of a cylindrical surface, the third part is also a part of the spherical surface, and the first part, the second part and the third part are in size correspondence.

As an optimization, the impact-resistant elastic material is selected from any one of nylon, PC, and PC+ABS.

As an optimization, the first component comprises an edge, wherein the edge is fixedly connected to the first body around an edge of the first body, and a width of the edge has a value range of ≦3 mm.

In order to achieve the second objective, A second component comprises a second body, wherein the second body is of a semi-open structure and has a receiving space, the receiving space is dimensionally adaptive to a mobile terminal to be received, the second body comprises a first sidewall, a second sidewall, a third sidewall, a fourth sidewall and a bottom surface that are connected end to end in sequence, the first sidewall, the second sidewall, the third sidewall and the fourth sidewall are in equal height, the first sidewall, the second sidewall, the third sidewall and the fourth sidewall are fixedly connected at the periphery of the bottom surface through their bottom edges, four corners of a back of the bottom surface are respectively provided with a first through hole, a second through hole, a third through hole and a fourth through hole, and the first through hole, the second through hole, the third through hole and the fourth through hole are used respectively to fit with any one of the first components of claims 1 to 3 so that after the first component is fitted to the second component, the first part, the second part and the third part are arranged outward.

As an optimization, the first sidewall, the second sidewall, the third sidewall, the fourth sidewall and the bottom surface are integrally formed.

As an optimization, the first component and the second component are detachably connected together or integrally formed.

As an optimization, each of four corners of a front of each of the first sidewall, the second sidewall, the third sidewall and the fourth sidewall is provided with a protrusion structure that is made of an elastic material.

As an optimization, the first sidewall, the second sidewall, the third sidewall, the fourth sidewall and the bottom surface are provided with a plurality of through holes according to various function keys of a mobile terminal to be received.

As an optimization, the third sidewall is provided with a notch extending from a width direction of the mobile terminal to be received to a thickness direction.

As an optimization, the notch further has room for the function keys of the mobile terminal to be received.

As an optimization, the second component is made of a deformation-resistant hard material or a flexible material.

In order to achieve the third objective, a mobile terminal protective shell comprises four first components and a second component, wherein the four first components are respectively fitted to the first through hole, the second through hole, the third through hole and the fourth through hole.

The mobile terminal protective shell of the invention comprises four first components and a second component, the first four components being fitted respectively to a first through hole, a second through hole, a third through hole and a fourth through hole. After application of this mobile terminal protective shell, when the mobile terminal directly slides and falls down to the ground, the protective shell can disperse the force to protect the mobile terminal.

### BRIEF DESCRIPTION OF THE DRAWINGS

FIG. 1 is a typical direction stereo view of a mobile terminal protective shell provided by an embodiment of the utility model;

FIG. 2 is a second typical direction view of a mobile terminal protective shell provided by an embodiment of the utility model;

FIG. 3 is a third typical direction view of a mobile terminal protective shell provided by an embodiment of the utility model;

FIG. 4 is a fourth typical direction view of a mobile terminal protective shell provided by an embodiment of the utility model;

FIG. 5 is a fifth typical direction view of a mobile terminal protective shell receiving a mobile terminal provided by the utility model;

FIG. 6 is another typical direction stereo view of a mobile terminal protective shell provided by an embodiment of the utility model.

### DETAILED DESCRIPTION OF THE INVENTION

In sequence to solve the problems of the prior art, the invention provides two components and a mobile terminal protective shell, where the two components can be assembled together to form the mobile terminal protective shell; after application of this mobile terminal protective shell, when the mobile terminal directly slides and falls down to the ground, the protective shell can disperse the force to protect the mobile terminal, so that it becomes more suitable for practical use. The mobile terminal may be a mobile phone or personal digital assistant (PDA).

To further illustrate the technical means and efficacy taken for the invention to achieve the intended purpose of the utility model, the detailed description, structure, characteristics and effect of the two components and the mobile terminal protective shell proposed by the invention will be described in details below with reference to the accompanying drawings and the preferred embodiments. In the following description, different “an embodiment” and “the embodiment” are not necessarily referring to the same embodiment. In addition, particular features, structures, or characteristics of one or more embodiments may be combined in any suitable forms.

### Embodiment 1

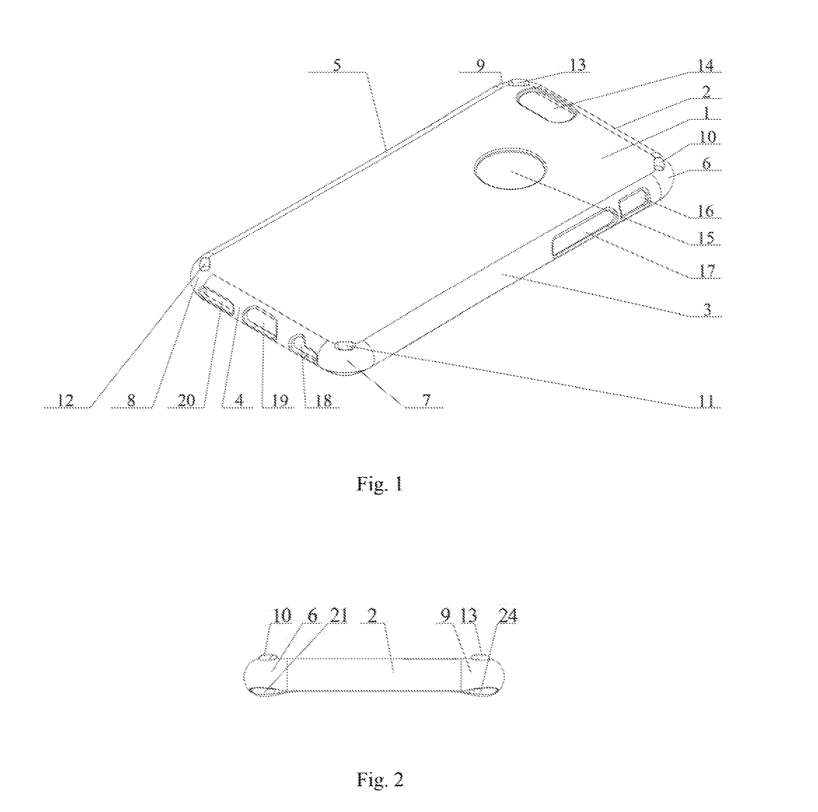

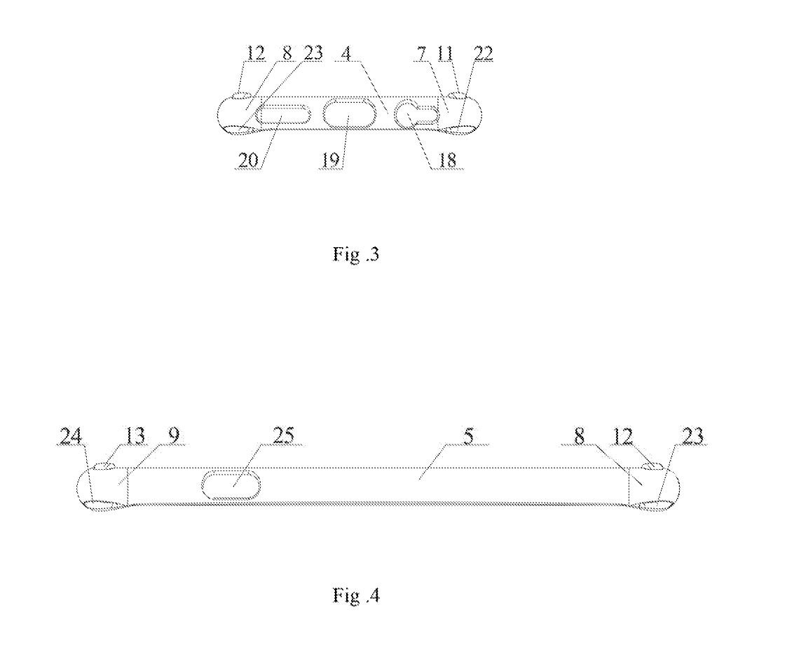

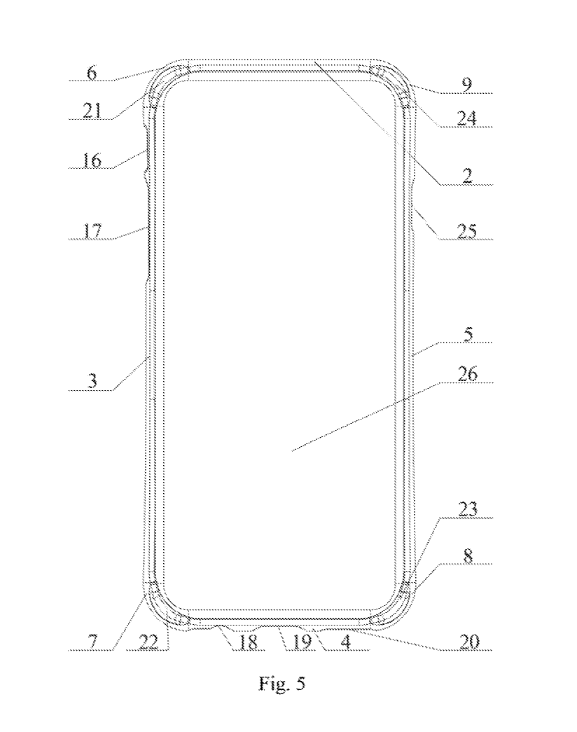

Referring to FIGS. 1-5, the embodiment is described by using an example of a mobile terminal protective shell formed only by fourth first components (a first first component 10, a second first component 11, a third first component 12 and a fourth first component 13) and a second component 1.

The mobile terminal protective shell provided by the embodiment of the present invention includes four first components (the first first component 10, the second first component 11, the third first component 12, the fourth first component 13) and a second component 1 provided by the present utility model, the four first components (the first first component 10, the second first component 11, the third first component 12, the fourth first component 13) are fitted to a first through hole (not numbered in the figures), a second through hole (not numbered in the figures), a third through hole (not numbered in the figures) and a fourth through hole (not numbered in the figures) respectively.

After application of this mobile terminal protective shell, when the mobile terminal directly slides and falls down to the ground, the protective shell can disperse the force to protect the mobile terminal.

The first components (the first first component 10, the second first component 11, the third first component 12, the fourth first component 13) include a first body (not numbered in the figures), where the first body (not numbered in the figures) is made of an impact-resistant elastic material, the first body (not numbered in the figures) includes a first part (not numbered in the figures), a second part (not numbered in the figures) and a third part (not numbered in the figures) that are connected in sequence, the first part (not numbered in the figures) is a part of a spherical surface, the second part (not numbered in the figures) is a part of a cylindrical surface, the third part (not numbered in the figures) is also a part of the spherical surface, the first part (not numbered in the figures), the second part (not numbered in the figures) and the third part (not numbered in the figures) are in size correspondence, a diameter of the spherical surface ranges from 1 mm to 3 mm, and a busbar of the cylindrical surface ranges from 1 mm to 5 mm.

The impact-resistant elastic material is selected from any one of nylon, polycarbonate (PC), PC+ABS (acrylonitrile butadiene styrene).

The first components (the first first component 10, the second first component 11, the third first component 12, the fourth first component 13) further include an edge (not numbered in the figures), where the edge (not numbered in the figures) is fixedly connected to the first body (not numbered in the figures) around an edge (not numbered in the figures) of the first body (not numbered in the figures), and a width of the edge (not numbered in the figures) has a value range of ≦3 mm, facilitating an assembly of the first components (the first first component 10, the second first component 11, the third first component 12, the fourth first component 13) with the second component.

The second component includes a second body, where the second body is of a semi-open structure and has a receiving space, the receiving space is dimensionally adaptive to a mobile terminal 26 to be received; the second body includes a first sidewall 2, a second sidewall 3, a third sidewall 4, a fourth sidewall 5 and a bottom surface 1 that are connected end to end in sequence, the first sidewall 2, the second sidewall 3, the third sidewall 4 and the fourth sidewall 5 are equal in height, the first sidewall 2, the second sidewall 3, the third sidewall 4 and the fourth sidewall 5 are fixedly connected all around the bottom surface 1 through their bottom edges, four corners of a back of the bottom surface 1 are respectively provided with a first through hole (not numbered in the figures), a second through hole (not numbered in the figures), a third through hole (not numbered in the figures) and a fourth through hole (not numbered in the figures), the first through hole (not numbered in the figures), the second through hole (not numbered in the figures), the third through hole (not numbered in the figures) and the fourth through hole (not numbered in the figures) are used respectively to fit with the first components (10, the second first component 11, the third first component 12, the fourth first component 13), so that after the first components (the first first component 10, the second first component 11, the third first component 12, the fourth first component 13) are fitted to the second component, the first part (not numbered in the figures), the second part (not numbered in the figures) and the third part (not numbered in the figures) are arranged outward.

The first sidewall 2, the second sidewall 3, the third sidewall 4, the fourth sidewall 5, and the bottom surface 1 are integrally formed, thereby omitting installation steps and facilitating application.

The first component (the first first component 10, the second first component 11, the third first component 12, the fourth first component 13) and the second component are detachably connected together so as to facilitate replacement of the first component (the first first component 10, the second first component 11, the third first component 12, the fourth first component 13) or to be integrally formed to omit installation steps for facilitating applications.

Each of four corners of a front of each of the first sidewall 2, the second sidewall 3, the third sidewall 4 and the fourth sidewall 5 is provided with a protrusion structure (a first protrusion structure 21, a second protrusion structure 22, a third protrusion structure 23 and a fourth protrusion structure 24), the protrusion structures (the first protrusion structure 21, the second protrusion structure 22, the third protrusion structure 23 and the fourth protrusion structure 24) are made of elastic materials, so as to avoid damages to the mobile terminal when it slides with its front facing downwards.

The first sidewall 2, the second sidewall 3, the third sidewall 4, the fourth sidewall 5 and the bottom surface 1 are provided with a plurality of through holes (a fifth through hole 14, a sixth through hole 15, a seventh through hole 16, an eighth through hole 17, a ninth through hole 18, a tenth through hole 19, an eleventh through hole 20 and a twelfth through hole 25) according to function keys of the mobile terminal 26 to be received.

The second component is made of a deformation-resistant hard material or a flexible material, so as to avoid deformation of the mobile terminal protective shell after prolonged periods of use.

### Embodiment 2

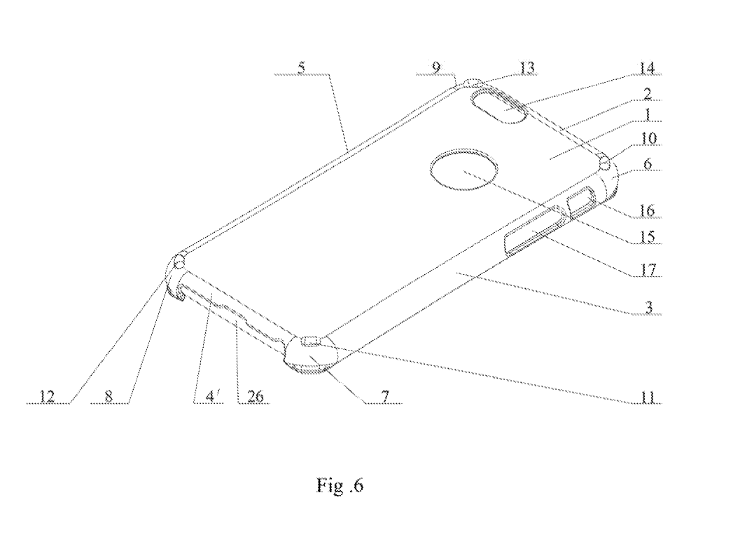

Referring to FIG. 6, differing from the mobile terminal protective shell according to the first embodiment of the present utility model, in the mobile terminal protective shell according to the second embodiment of the present utility model, a third sidewall 4′ has a notch extending from a width direction towards of the mobile terminal 26 to be received to a thickness direction. In this case, after the mobile terminal 26 to be received is received into a receiving space, to avoid the mobile terminal 26 to be removed from the receiving space, upper edges of the first sidewall 2, the second sidewall 3 and the fourth sidewall 5 are generally arranged to be inwardly-extending edges extending towards the center of the upper surface of the mobile terminal 26 at most 2 mm, and the mobile terminal 26 may be prevented from being removed from the receiving space through the blocking of the inwardly-extending edges. However, outer dimensions of the mobile terminal 26 to be received may be larger than those of the inwardly-extending edges, which tend to cause it hard to place the mobile terminal 26 to be received into the receiving space. At this time, if the notch is provided on the third sidewall 4′, since the notch corresponds to a barrier, it may reduce the restriction of the third sidewall 4′, increasing the elasticity of the first sidewall 2, the second sidewall 3 and the fourth sidewall 5, so that it temporarily results in a receiving space having outre dimensions larger than those of the mobile terminal 26 to be received, facilitating the placement of the mobile terminal 26 to be received into the receiving space, and ensuring that the first sidewall 2, the second sidewall 3 and the fourth sidewall 5 may be smoothly reset after the mobile terminal 26 to be received is placed into the receiving space, and the mobile terminal 26 is blocked in the receiving space by the inwardly-extending edges.

In this embodiment, the notch also makes room for the function keys of the mobile terminal 26 to be received.

It is obvious that those skilled in the art may make various modifications and variations without departing from the spirit and scope of the present utility model. So, if these modifications and variations to the present invention fall within the scope of the claims and their equivalents thereof, the present invention is intended to embrace all such modifications and variations.

What is claimed is:

1. A first component, comprising a first body, wherein the first body is made of an impact-resistant elastic material and comprises a first part, a second part and a third part that are connected in sequence, the first part is a part of a spherical surface, the second part is a part of a cylindrical surface, the third part is also a part of the spherical surface, and the first part, the second part and the third part are in size correspondence.

2. The first component according to claim 1, wherein the impact-resistant elastic material is selected from any one of nylon, polycarbonate (PC), and PC+ABS (acrylonitrile butadiene styrene).

3. The first component according to claim 1, further comprising an edge, wherein the edge is fixedly connected to the first body around an edge of the first body, and a width of the edge has a value range of ≦3 mm.

4. A second component, comprising a second body, wherein the second body is of a semi-open structure and has a receiving space, the receiving space is dimensionally adaptive to a mobile terminal to be received, the second body comprises a first sidewall, a second sidewall, a third sidewall, a fourth sidewall and a bottom surface that are connected end to end in sequence, the first sidewall, the second sidewall, the third sidewall and the fourth sidewall are in equal height, the first sidewall, the second sidewall, the third sidewall and the fourth sidewall are fixedly connected at the periphery of the bottom surface through their bottom edges, four corners of a back of the bottom surface are respectively provided with a first through hole, a second through hole, a third through hole and a fourth through hole, and the first through hole, the second through hole, the third through hole and the fourth through hole are used respectively to fit with the first component of claim 1 so that after the first component is fitted to the second component, the first part, the second part and the third part are arranged outward.

5. The second component according to claim 4, wherein the first sidewall, the second sidewall, the third sidewall, the fourth sidewall and the bottom surface are integrally formed.

6. The second component according to claim 4, wherein the first component and the second component are detachably connected together or integrally formed.

7. The second component according to claim 4, wherein each of four corners of a front of each of the first sidewall, the second sidewall, the third sidewall and the fourth sidewall is provided with a protrusion structure that is made of an elastic material.

8. The second component according to claim 4, wherein the first sidewall, the second sidewall, the third sidewall, the fourth sidewall and the bottom surface are provided with a plurality of through holes according to various function keys of a mobile terminal to be received.

9. The second component according to claim 4, wherein the third sidewall is provided with a notch extending from a width direction of the mobile terminal to be received to a thickness direction.

10. The second component according to claim 9, wherein the notch further has room for the function keys of the mobile terminal to be received.

11. The second component according to claim 4, wherein the second component is made of a deformation-resistant hard material or a flexible material.

12. A mobile terminal protective shell, comprising four first components and a second component, wherein the four first components are respectively fitted to a first through hole, a second through hole, a third through hole and a fourth through hole, the first component comprising a first body, wherein the first body is made of an impact-resistant elastic material and comprises a first part, a second part and a third part that are connected in sequence, the first part is a part of a spherical surface, the second part is a part of a cylindrical surface, the third part is also a part of the spherical surface, and the first part, the second part and the third part are in size correspondence.

13. The mobile terminal protective shell according to claim 12, wherein the second component comprising a second body, wherein the second body is of a semi-open structure and has a receiving space, the receiving space is dimensionally adaptive to a mobile terminal to be received, the second body comprises a first sidewall, a second sidewall, a third sidewall, a fourth sidewall and a bottom surface that are connected end to end in sequence, the first sidewall, the second sidewall, the third sidewall and the fourth sidewall are in equal height, the first sidewall, the second sidewall, the third sidewall and the fourth sidewall are fixedly connected at the periphery of the bottom surface through their bottom edges, four corners of a back of the bottom surface are respectively provided with a first through hole, a second through hole, a third through hole and a fourth through hole, and the first through hole, the second through hole, the third through hole and the fourth through hole are used respectively to fit with the first components of claims iso that after the first component is fitted to the second component, the first part, the second part and the third part are arranged outward.

14. The mobile terminal protective shell according to claim 12, wherein the first sidewall, the second sidewall, the third sidewall, the fourth sidewall and the bottom surface are integrally formed.

15. The mobile terminal protective shell according to claim 12, wherein the first component and the second component are detachably connected together or integrally formed.

16. The mobile terminal protective shell according to claim 12, wherein each of four corners of a front of each of the first sidewall, the second sidewall, the third sidewall and the fourth sidewall is provided with a protrusion structure that is made of an elastic material.

17. The mobile terminal protective shell according to claim 12, wherein the first sidewall, the second sidewall, the third sidewall, the fourth sidewall and the bottom surface are provided with a plurality of through holes according to various function keys of a mobile terminal to be received.

18. The mobile terminal protective shell according to claim 12, wherein the third sidewall is provided with a notch extending from a width direction of the mobile terminal to be received to a thickness direction.

19. The mobile terminal protective shell according to claim 18, wherein the notch further has room for the function keys of the mobile terminal to be received.
